(19) United States
(12) Patent Application Publication
(10) Pub. No.: US 2015/0197115 A1
(43) Pub. Date: Jul. 16, 2015

(54) RECORDING MEDIUM

(71) Applicant: CANON KABUSHIKI KAISHA, Tokyo (JP)

(72) Inventors: Naoya Hatta, Kawasaki-shi (JP); Hisao Kamo, Ushiku-shi (JP); Isamu Oguri, Yokohama-shi (JP); Olivia Herlambang, Kawasaki-shi (JP); Masahito Miyabe, Yokohama-shi (JP); Shinya Yumoto, Kawasaki-shi (JP); Shoichi Takeda, Kawasaki-shi (JP)

(21) Appl. No.: 14/591,793

(22) Filed: Jan. 7, 2015

(30) Foreign Application Priority Data
Jan. 10, 2014 (JP) 2014-003146

(51) Int. Cl. B41M 5/52

(52) U.S. Cl. CPC B41M 5/5218; B41M 5/5254; B41M 5/5227

(57) ABSTRACT

A recording medium includes a base material and an ink-receiving layer. The ink-receiving layer contains inorganic particles, a binder, and a compound A. The compound A contains a unit derived from a compound represented by General Formula (1) and a unit derived from at least one compound selected from compounds represented by General Formula (2) and compounds represented by General Formula (3).

### BACKGROUND OF THE INVENTION

1. Field of the Invention

The present invention relates to a recording medium.

2. Description of the Related Art

Recording media that include an ink-receiving layer containing inorganic particles have high ink absorbency and color developability of images. Recording media that include an ink-receiving layer containing inorganic particles are generally manufactured by applying a coating liquid for the ink-receiving layer containing the inorganic particles to a base material and drying the coating liquid. However, this method has some problems, such as increased viscosity in the preparation of the coating liquid and cracking of the ink-receiving layer during the drying process.

In order to solve such coating problems, a method for modifying materials of an ink-receiving layer has been studied (Japanese Patent Laid-Open No. 2006-289779). According to Japanese Patent Laid-Open No. 2006-289779, cracking of an ink-receiving layer can be suppresses by using inorganic particles and polyglycerin having particular average molecular weight and hydroxyl value in the ink-receiving layer.

### SUMMARY OF THE INVENTION

A recording medium according to one aspect of the present invention includes a base material and an ink-receiving layer. The ink-receiving layer contains inorganic particles, a binder, and a compound A. The compound A contains a unit derived from a compound represented by General Formula (1) and a unit derived from at least one compound selected from compounds represented by General Formula (2) and compounds represented by General Formula (3).

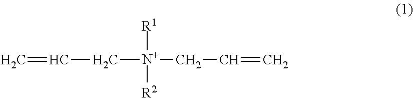

In General Formula (1), R² and R² each independently represent an alkyl group having 1 to 10 carbon atoms, a cycloalkyl group having 5 to 10 carbon atoms, or an aralkyl group having 7 to 10 carbon atoms.

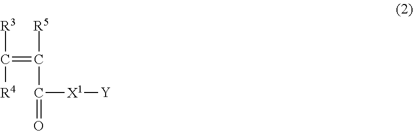

In General Formula (2), R³, R⁴, and R⁵ each independently represent hydrogen or an alkyl group having 1 to 4 carbon atoms, X¹ represents an oxygen atom or an amino group, and Y represents a hydroxyalkyl group or an aminoalkyl group each having 1 to 10 carbon atoms.

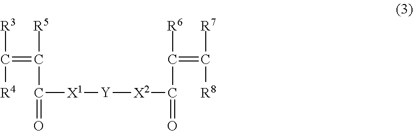

In General Formula (3), R³, R⁴, R⁵, R⁶, R⁷ and R⁸ each independently represent hydrogen or an alkyl group having 1 to 4 carbon atoms, X¹ and X² each independently represent an oxygen atom or an amino group, and Y represents a hydroxyalkylene group or an aminoalkylene group each having 1 to 10 carbon atoms.

Further features of the present invention will become apparent from the following description of exemplary embodiments.

### DESCRIPTION OF THE EMBODIMENTS

The present inventors found that cracking of an ink-receiving layer in a recording medium described in Japanese Patent Laid-Open No. 2006-289779 was not satisfactorily suppressed according to the criteria of the present invention. In particular, the ink-receiving layer had cracks when a coating liquid was dried at high speed with hot air at 90° C. or more after coating.

Accordingly, the present invention provides a recording medium that includes an ink-receiving layer resistant to cracking.

The present invention will be described in detail with the embodiments.

The present inventors think that cracking of an ink-receiving layer results from the low dispersion stability of inorganic particles or the weak interaction between inorganic particles and a binder. Thus, the present inventors have developed a method for dispersing inorganic particles using a compound A described below in order to improve the dispersion stability of the inorganic particles and enhance the interaction between the inorganic particles and a binder.

The compound A contains a unit (first unit) derived from a compound represented by General Formula (1) and a unit (second unit) derived from at least one compound selected from compounds represented by General Formula (2) and compounds represented by General Formula (3). The first unit can improve the dispersion stability of the inorganic particles, and the second unit having a hydroxyl group can enhance the interaction between the inorganic particles and the binder.

### [Recording Medium]

A recording medium according to an embodiment of the present invention includes a base material and an ink-receiving layer. A recording medium according to an embodiment of the present invention may be an ink jet recording medium for use in an ink jet recording method. The components of a recording medium according to an embodiment of the present invention will be described below.

### <Base Material>

The base material may be a base paper or may include a base paper and a resin layer, for example, a base paper coated with a resin. In an embodiment of the present invention, the base material may include a base paper and a resin layer. The resin layer may be disposed on one or both sides of the base paper.

### Base Paper

The base paper is composed mainly of wood pulp. If necessary, the base paper is composed of wood pulp and synthetic pulp, such as polypropylene pulp, or synthetic fibers, such as nylon or polyester fibers. Examples of the wood pulp include, but are not limited to, leaf bleached kraft pulp (LBKP), leaf bleached sulfite pulp (LBSP), needle bleached kraft pulp (NBKP), needle bleached sulfite pulp (NBSP), leaf dissolving pulp (LDP), needle dissolving pulp (NDP), leaf unbleached kraft pulp (LUKP), and needle unbleached kraft pulp (NUKP). These wood pulps may be used alone or in combination as required. The wood pulp may be LBKP, NBSP, LBSP, NDP, or LDP, which contains a large amount of short fiber component. The pulp may be chemical pulp (sulfate pulp or sulfite pulp) containing less impurities. The pulp may be bleached to increase the degree of whiteness. The base paper may contain a sizing agent, a white pigment, a paper strengthening agent, a fluorescent brightening agent, a water-retaining agent, a dispersant, and/or a softening agent.

In an embodiment of the present invention, the base paper preferably has a thickness of 50 μm or more and 130 μm or less, more preferably 90 μm or more and 120 μm or less. In an embodiment of the present invention, the thickness of the base paper is calculated using the following method. First, a recording medium is cut with a microtome, and the cross section is observed with a scanning electron microscope. The thickness measurements at 100 or more points are averaged to determine the thickness of the base paper. The thickness of another layer in an embodiment of the present invention is also determined in the same manner.

In an embodiment of the present invention, the base paper preferably has a density of 0.6 g/cm³ or more and 1.2 g/cm³ or less, more preferably 0.7 g/cm³ or more and 1.2 g/cm³ or less, in accordance with JIS P 8118.

### Resin Layer

In an embodiment of the present invention where the base paper is coated with a resin, the resin layer may cover part of the surface of the base paper. The coverage by the resin layer (the area of a surface of the base paper coated with the resin layer/the full surface area of the base paper) is preferably 70% or more, more preferably 90% or more, particularly preferably 100%; that is, the full surface of the base paper is particularly preferably covered with the resin layer.

In an embodiment of the present invention, the resin layer preferably has a thickness of 20 μm or more and 60 μm or less, more preferably 35 μm or more and 50 μm or less. The resin layer on each side of the base paper may have a thickness in the range described above.

The resin layer may be formed of a thermoplastic resin. Examples of the thermoplastic resin include, but are not limited to, acrylic resins, acrylic silicone resins, polyolefin resins, and styrene-butadiene copolymers. Among these, the thermoplastic resin may be a polyolefin resin. The term “polyolefin resin”, as used herein, refers to a polymer of an olefin monomer. More specifically, the polyolefin resin may be a homopolymer or a copolymer of ethylene, propylene, and/or isobutylene. These polyolefin resins may be used alone or in combination as required. Among these, the polyolefin resin may be polyethylene. The polyethylene may be a low-density polyethylene (LDPE) or a high-density polyethylene (HDPE).

In an embodiment of the present invention, the resin layer may contain a white pigment, a fluorescent brightening agent, and/or an ultramarine blue pigment in order to control its opacity, degree of whiteness, and/or hue. In particular, the resin layer may contain a white pigment in order to improve its opacity. Examples of the white pigment include, but are not limited to, rutile and anatase titanium oxides. In an embodiment of the present invention, the white pigment content of the resin layer may be 3 g/m² or more and 30 g/m² or less. For resin layers disposed on both sides of the base paper, the total white pigment content of the two resin layers may be in the range described above. The white pigment content of the resin layer may be 25% by mass or less of the resin content. A white pigment content of more than 25% by mass may result in insufficient dispersion stability of the white pigment.

### <Ink-Receiving Layer>

In an embodiment of the present invention, the ink-receiving layer contains inorganic particles, a binder, and a compound A. In an embodiment of the present invention, the ink-receiving layer may be a monolayer or a multilayer. The ink-receiving layer may be disposed on one or both sides of the base material. The ink-receiving layer preferably has a thickness of 15 μm or more and 60 μm or less, more preferably 30 μm or more and 45 μm or less. The materials of the ink-receiving layer will be described below.

### Compound A

In an embodiment of the present invention, the ink-receiving layer contains a compound A, which contains a unit derived from a compound represented by General Formula (1) and a unit derived from at least one compound selected from compounds represented by General Formula (2) and compounds represented by General Formula (3).

In an embodiment of the present invention, the compound A can be a copolymer of a compound represented by General Formula (1) and at least one compound selected from compounds represented by General Formula (2) and compounds represented by General Formula (3).

The compounds represented by General Formulae (1) to (3) will be described below. The term “(meth)acrylate”, as used herein, includes “acrylate” and “methacrylate”.

### <1> Compound Represented by General Formula (1)

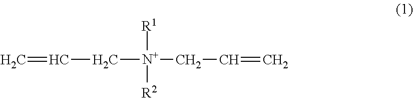

In General Formula (1), R¹ and R² independently represent an alkyl group having 1 to 10 carbon atoms, a cycloalkyl group having 5 to 10 carbon atoms, or an aralkyl group having 7 to 10 carbon atoms.

The compounds represented by General Formula (1), which are cations, can be combined with counter ions, that is, anions. Specific examples of the anions include, but are not limited to, halide ions, sulfonate ion, alkyl sulfonate ions, acetate ion, and alkyl carboxylate ions.

Examples of the compounds represented by General Formula (1) include, but are not limited to, diallyldimethylammonium, diallylmethylbenzylammonium, and diallyldibenzylammonium. Among these, diallyldimethylammonium chloride, which includes a chloride ion as an anion, may be used.

### <2> Compounds Represented by General Formulae (2) and (3)

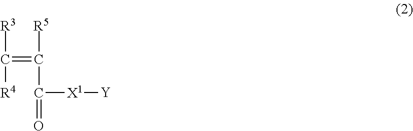

In General Formula (2), R³, R⁴, and R⁵ independently represent hydrogen or an alkyl group having 1 to 4 carbon atoms. X¹ represents an oxygen atom or an amino group. Y represents a hydroxyalkyl group or an aminoalkyl group each having 1 to 10 carbon atoms. The term “hydroxyalkyl group”, as used herein, also refers to a group having a plurality of hydroxyl groups, such as a dihydroxyalkyl group. Y can represent a hydroxyalkyl group having 1 to 10 carbon atoms.

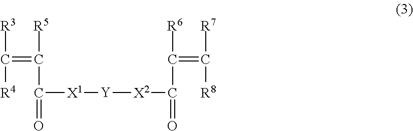

In General Formula (3), R³, R⁴, R⁵, R⁶, R⁷ and R⁸ independently represent hydrogen or an alkyl group having 1 to 4 carbon atoms. X¹ and X² independently represent an oxygen atom or an amino group. Y represents a hydroxyalkylene group or an aminoalkylene group each having 1 to 10 carbon atoms. The term “hydroxyalkylene group”, as used herein, also refers to a group having a plurality of hydroxyl groups, such as a dihydroxyalkylene group.

Examples of the compounds represented by General Formula (2) include, but are not limited to, hydroxyalkyl(meth)acrylates, such as 2-hydroxyethyl(meth)acrylate, 3-hydroxypropyl(meth)acrylate, 4-hydroxybutyl(meth)acrylate, 2-hydroxybutyl(meth)acrylate, and 3,4-dihydroxybutyl(meth)acrylate; hydroxyalkyl(meth)acrylamides, such as 2-hydroxyethyl(meth)acrylamide; aminoalkyl(meth)acrylates, such as aminoethyl(meth)acrylate, aminopropyl(meth)acrylate, and aminobutyl(meth)acrylate; and aminoalkyl(meth)acrylamides, such as aminoethyl(meth)acrylamide. Examples of the compounds represented by General Formula (3) include, but are not limited to, 2-hydroxy-3-acryloyloxypropyl(meth)acrylate and glycerin di(meth)acrylate. Among these, hydroxyalkyl(meth)acrylates may be used, and at least one selected from 4-hydroxybutyl(meth)acrylate, 2-hydroxybutyl(meth)acrylate, and 2-hydroxyethyl(meth)acrylate may be used.

The mole ratio of the unit derived from a compound represented by General Formula (1) to the unit derived from at least one compound selected from compounds represented by General Formula (2) and compounds represented by General Formula (3) in the compound A can be 1.0 or more and 9.0 or less. This range can result in improved dispersion stability of the inorganic particles and enhanced interaction between the inorganic particles and the binder.

In the case where the binder is poly(vinyl alcohol), the hydroxyl group content of the compound A is 1% by mass or more and 10% by mass or less of the hydroxyl group content of the poly(vinyl alcohol).

In an embodiment of the present invention, the compound A preferably has a weight-average molecular weight of 2,000 or more and 30,000 or less, more preferably 5,000 or more and 20,000 or less.

In an embodiment of the present invention, a chain transfer agent can be used to control the weight-average molecular weight of the compound A. Examples of the chain transfer agent include, but are not limited to, thiol chain transfer agents, such as mercaptoethanol, thioglycolic acid, 2-mercaptopropionic acid, 3-mercaptopropionic acid, octyl 3-mercaptopropionate, 2-mercaptoethanesulfonic acid, and n-dodecyl mercaptan; halides, such as carbon tetrachloride, methylene chloride, bromoform, and bromotrichloroethane; secondary alcohols, such as isopropanol and glycerin; phosphorous acid, hypophosphorous acid, and salts thereof (sodium hypophosphite and potassium hypophosphite); and bisulfite, compounds that can produce bisulfite, such as metabisulfite, dithionous acid, and sulfurous acid, and salts thereof. Among these, hypophosphorous acid or a salt thereof may be used.

The compound A can be synthesized using a conventional method. For example, the compound A can be synthesized by heating a compound represented by General Formula (1), at least one compound selected from compounds represented by General Formula (2) and compounds represented by General Formula (3), a polymerization initiator, and a chain transfer agent in an aqueous solvent. Examples of the polymerization initiator include, but are not limited to, persulfate radical initiators, such as ammonium persulfate, potassium persulfate, and sodium persulfate; and azo initiators, such as 2,2′-azobis(2-amidinopropane), 2,2′-azobis(2-amidinobutane), 2,2′-azobis(2-amidinopentane), 2,2′-azobis(2-amidino-3-methylbutane), 3,3′-azobis(3-amidinopentane), 3,3′-azobis(3-amidinohexane), 3,3′-azobis(3-amidino-4-methylpentane), 4,4′-azobis(4-amidinoheptane), 2,2′-azobis(2-methylpropionamidine) hydrochloride, and 2,2′-azobis[N-(2-carboxyethyl)-2-methylpropionamidine]. The amount of polymerization initiator to be used is preferably 0.8% by mass or more and 20.0% by mass or less, more preferably 1.0% by mass or more and 10.0% by mass or less, of the total amount of a compound represented by General Formula (1) and at least one compound selected from compounds represented by General Formula (2) and compounds represented by General Formula (3). Examples of the aqueous solvent for use in the synthesis include, but are not limited to, water; inorganic acids, such as hydrochloric acid, sulfuric acid, phosphoric acid, and polyphosphoric acid; organic acids, such as formic acid, acetic acid, propionic acid, and lactic acid; alcohols, dimethyl sulfoxide, and dimethylformamide; and zinc chloride, calcium chloride, and magnesium chloride. The heating temperature in the synthesis of the compound A depends on the materials and can be 50° C. or more and 80° C. or less.

### Inorganic Particles

In an embodiment of the present invention, the ink-receiving layer contains inorganic particles. Examples of the inorganic particles include, but are not limited to, fumed silica, alumina hydrate, fumed alumina, colloidal silica, titanium dioxide, zeolite, kaolin, talc, hydrotalcite, zinc oxide, zinc hydroxide, aluminum silicate, calcium silicate, magnesium silicate, zirconium oxide, and zirconium hydroxide. These inorganic particles may be used alone or in combination as required. Among these inorganic particles, fumed silica, alumina hydrate, and fumed alumina may be used. In particular, fumed silica, that is, fumed silica having a group represented by General Formula (1) may be used.

Examples of the fumed silica include, but are not limited to, Aerosil (trade name) series (manufactured by Evonik Industries AG.) and Reolosil (trade name) QS (manufactured by Tokuyama Corporation).

In an embodiment of the present invention, the fumed silica preferably has a BET specific surface area of 50 m²/g or more and 400 m²/g or less, more preferably 200 m²/g or more and 350 m²/g or less.

The alumina hydrate can have General Formula (X): Al₂O₃₋ₙ (OH)₂ₙ.mH₂O (wherein n is 0, 1, 2, or 3, and m is 0 or more and 10 or less, preferably 0 or more and 5 or less, provided that m or n is not 0). In many instances, mH₂O means a detachable aqueous phase not involved in the formation of a crystal lattice, and therefore m may not be an integer. When the alumina hydrate is heated, m may be 0.

In an embodiment of the present invention, the alumina hydrate may be produced using a known method. More specifically, the alumina hydrate may be produced by hydrolyzing an aluminum alkoxide, hydrolyzing sodium aluminate, or neutralizing an aqueous sodium aluminate solution with an aqueous aluminum sulfate or aluminum chloride solution.

It is known that alumina hydrate has a crystal structure of amorphous, gibbsite, or boehmite, depending on the heat treatment temperature. The crystal structure of alumina hydrate can be analyzed using an X-ray diffraction method. In an embodiment of the present invention, among these, boehmite or amorphous alumina hydrate may be used. Specific examples of alumina hydrate include, but are not limited to, alumina hydrates described in Japanese Patent Laid-Open No. 7-232473, No. 8-132731, No. 9-66664, and No. 9-76628 and commercial products Disperal (trade name) HP14 and HP18 (manufactured by Sasol). These alumina hydrates may be used alone or in combination as required.

In an embodiment of the present invention, the alumina hydrate preferably has a BET specific surface area of 100 m²/g or more and 200 m²/g or less, more preferably 125 m²/g or more and 175 m²/g or less. The BET specific surface area is determined from the number of molecules or ions having a known size adsorbed on the surface of a sample. In an embodiment of the present invention, a gas to be adsorbed on the surface of a sample is nitrogen gas.

Examples of the fumed alumina include, but are not limited to, γ-alumina, α-alumina, δ-alumina, θ-alumina, and χ-alumina. Among these, γ-alumina can provide high image optical density and ink absorbency. Specific examples of the fumed alumina include, but are not limited to, Aeroxide (trade name) Alu C, Alu 130, and Alu 65 (manufactured by Evonik Industries AG.).

In an embodiment of the present invention, the fumed alumina preferably has a BET specific surface area of m²/g or more, more preferably 80 m²/g or more, and preferably 150 m²/g or less, more preferably 120 m²/g or less.

### Inorganic Particles Having Structure Represented by General Formula (4)

In an embodiment of the present invention, the inorganic particles can have a structure represented by General Formula (4). Such inorganic particles can improve the moisture resistance of images. The term “moisture resistance”, as used herein, refers to the ability to suppress blurring of images on a recording medium stored under high-humidity conditions.

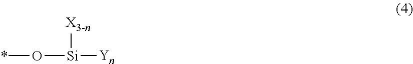

The structure represented by General Formula (4) is bonded to a surface of the inorganic particle at a position marked with *. In General Formula (4), X represents an alkoxy group having 1 to 8 carbon atoms, an aryloxy group, an acetoxy group, a halogen atom, a hydrogen atom, a hydrocarbon group having 1 to 8 carbon atoms, or —O—*. The sentence “X represents —O—*” means that the silicon atom (Si) is bound to a surface of an inorganic particle via an oxygen atom (O). The inorganic particle(s) bound to “*” may be one or more particles. Since the inorganic particles are much larger than the groups represented by General Formula (4), “*” is generally bound to one inorganic particle. Y represents a structure including a primary hydroxyl group. The index n is 1, 2, or 3 and may be 1.

In an embodiment of the present invention, a structure represented by General Formula (4) can be a structure represented by General Formula (5). In other words, the ink-receiving layer can contain inorganic particles having a structure represented by General Formula (5).

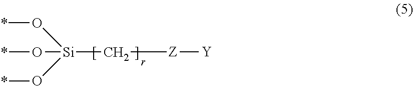

The symbol * in a structure represented by General Formula (5) is bound to a surface of an inorganic particle. In General Formula (5), Z represents a single bond, an amide group, an ether group, a carbonyl group, or an ester group. Among these, Z can represent a single bond, an amide group, or an ether group. The sentence “Z represents a single bond” means that Y is directly bound to a methylene group (—CH₂—). Y represents a structure including a primary hydroxyl group. The index r is an integer in the range of 0 to 5.

In an embodiment of the present invention, Y in General Formula (4) or (5) can have a structure represented by General Formula (6).

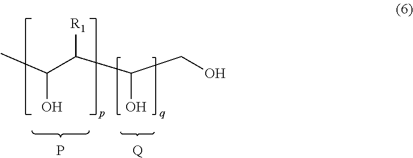

In General Formula (6), R¹ represents a hydrogen atom or a hydrocarbon group having 1 to 8 carbon atoms. The index p+q is an integer of 1 or more. The P structure and the Q structure may be arranged in any order. More specifically, General Formula (6) includes not only —P—P—P—P-Q-Q- but also -Q-Q-Q—P—P—P—, alternate arrangements, such as —P-Q-P-Q-P-Q-, and random arrangements, such as —P—P-Q-P-Q-Q-.

In an embodiment of the present invention, the inorganic particles having a structure represented by General Formula (4) can be produced, for example, by modifying the surfaces of the inorganic particles with a compound represented by General Formula (7).

X₄₋ₙ—Si—Yₙ (7)

In General Formula (7), X represents an alkoxy group having 1 to 8 carbon atoms, an aryloxy group, or an acetoxy group. Y represents a structure including a primary hydroxyl group. The index n is 1, 2, or 3.

The inorganic particles have a hydroxyl group on the surface thereof. The inorganic particles having a structure represented by General Formula (4) are produced by the reaction between a compound represented by General Formula (7) and a hydroxyl group on the surface of the inorganic particles.

In an embodiment of the present invention, a compound represented by General Formula (7) can be at least one selected from the following compounds H-1 to H-4. In the following formula, R represents a hydrogen atom or a hydrocarbon group having 1 to 8 carbon atoms.

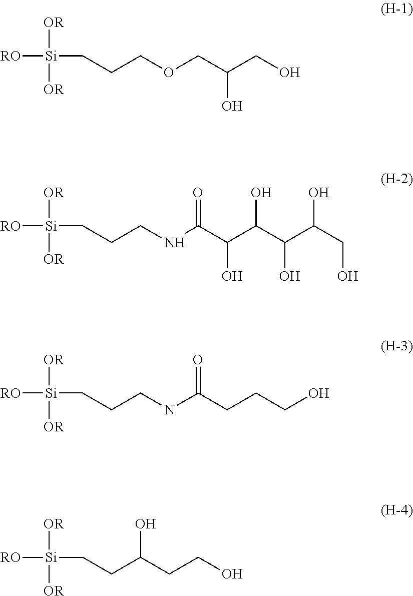

In an embodiment of the present invention, the amount of structure represented by General Formula (4) in inorganic particles having a structure represented by General Formula (4) is preferably 1% by mass or more and 15% by mass or less, more preferably 2% by mass or more and 10% by mass or less, of the amount of the inorganic particles. In order to satisfy these ratios, the amount of compound represented by General Formula (7) to be used in the surface modification of the inorganic particles is preferably 1% by mass or more and 15% by mass or less, more preferably 2% by mass or more and 10% by mass or less, of the amount of the inorganic particles.

In an embodiment of the present invention, the amount of inorganic particles having a structure represented by General Formula (4) (% by mass) of the ink-receiving layer is preferably 50% by mass or more and 98% by mass or less, more preferably 70% by mass or more and 96% by mass or less.

In an embodiment of the present invention, the coating weight (g/m²) of the inorganic particles having a structure represented by General Formula (4) in the formation of the ink-receiving layer may be 8 g/m² or more and 45 g/m² or less. This range can result in the ink-receiving layer having a desired film thickness.

### Binder

In an embodiment of the present invention, the ink-receiving layer contains a binder. The term “binder”, as used herein, refers to a material that can bind inorganic particles together to form a film.

In an embodiment of the present invention, the binder content of the ink-receiving layer is preferably 50% by mass or less, more preferably 30% by mass or less, of the inorganic particle content in terms of ink absorbency. The binder content of the ink-receiving layer is preferably 5.0% by mass or more, more preferably 8.0% by mass or more, of the inorganic particle content in terms of the binding of the ink-receiving layer.

Examples of the binder include, but are not limited to, starch derivatives, such as oxidized starch, etherified starch, and phosphorylated starch; cellulose derivatives, such as carboxymethylcellulose and hydroxyethylcellulose; casein, gelatin, soybean protein, poly(vinyl alcohol), and derivatives thereof; latexes of conjugated polymers, such as polyvinylpyrrolidone, maleic anhydride polymers, styrene-butadiene copolymers, and methyl methacrylate-butadiene copolymers; latexes of acrylic polymers, such as acrylate and methacrylate polymers; latexes of vinyl polymers, such as ethylene-vinyl acetate copolymers; latexes of functional-group-modified polymers, such as the polymers described above modified with a monomer having a functional group, such as a carboxy group; the polymers described above cationized using a cation group; the polymers described above having a surface cationized using a cation surfactant; the polymers described above having a surface on which poly(vinyl alcohol) is distributed by the polymerization of monomers constituting the polymers in the presence of cationic poly(vinyl alcohol); the polymers described above having a surface on which cationic colloidal particles are distributed by the polymerization of monomers constituting the polymers in a suspension of the cationic colloidal particles; aqueous binders of thermosetting synthetic polymers, such as melamine polymers and urea polymers; polymers and copolymers of acrylates and methacrylates, such as poly(methyl methacrylate); and synthetic polymers, such as polyurethane polymers, unsaturated polyester polymers, vinyl chloride-vinyl acetate copolymers, poly(vinyl butyral), and alkyd polymers. These binders may be used alone or in combination as required.

Among these binders, poly(vinyl alcohol) and poly(vinyl alcohol) derivatives may be used. Examples of the poly(vinyl alcohol) derivatives include, but are not limited to, cation-modified poly(vinyl alcohol), anion-modified poly(vinyl alcohol), silanol-modified poly(vinyl alcohol), and poly(vinyl acetal). The cation-modified poly(vinyl alcohol) may be poly(vinyl alcohol) having a primary, secondary, or tertiary amino group or a quaternary ammonium group in its main chain or side chain, as described in Japanese Patent Laid-Open No. 61-10483.

Poly(vinyl alcohol) may be synthesized by saponification of poly(vinyl acetate). The degree of saponification of poly(vinyl alcohol) is preferably 80% by mole or more and 100% by mole or less, more preferably 85% by mole or more and 98% by mole or less. The degree of saponification is the rate of the number of moles of hydroxy groups produced by saponification of poly(vinyl acetate) to produce poly(vinyl alcohol). In an embodiment of the present invention, the degree of saponification is determined in accordance with JIS K 6726. Poly(vinyl alcohol) preferably has an average degree of polymerization of 2,000 or more, more preferably 2,000 or more and 5,000 or less. In an embodiment of the present invention, the average degree of polymerization is the viscosity-average degree of polymerization determined in accordance with JIS K 6726.

A coating liquid for the ink-receiving layer may be prepared using an aqueous poly(vinyl alcohol) or poly(vinyl alcohol) derivative solution. The solid content of the aqueous poly(vinyl alcohol) or poly(vinyl alcohol) derivative solution may be 3% by mass or more and 20% by mass or less.

### Cross-Linker

In an embodiment of the present invention, the ink-receiving layer can further contain a cross-linker. Examples of the cross-linker include, but are not limited to, aldehyde compounds, melamine compounds, isocyanate compounds, zirconium compounds, amide compounds, aluminum compounds, boric acids, and borates. These cross-linkers may be used alone or in combination as required. In particular, when the binder is poly(vinyl alcohol) or a poly(vinyl alcohol) derivative, among these cross-linkers, boric acid or a borate may be used.

Examples of boric acids include, but are not limited to, orthoboric acid (H₃BO₃), metaboric acid, and hypoboric acid. Borates may be water-soluble salts of these boric acids. Examples of such borates include, but are not limited to, alkali metal salts of boric acid, such as sodium borate and potassium borate, alkaline-earth metal salts of boric acid, such as magnesium borate and calcium borate, and ammonium salts of boric acid. Among these, orthoboric acid can improve the temporal stability of a coating liquid and reduce the occurrence of cracks.

The amount of cross-linker used depends on the manufacturing conditions. In an embodiment of the present invention, the cross-linker content of the ink-receiving layer is preferably 1.0% by mass or more and 50% by mass or less, more preferably 5% by mass or more and 40% by mass or less, of the binder content.

When the binder is poly(vinyl alcohol) and when the cross-linker is at least one selected from boric acids and borates, the total boric acid and borate content may be 5% by mass or more and 30% by mass or less of the poly(vinyl alcohol) content of the ink-receiving layer.

### Other Additive Agents

In an embodiment of the present invention, the ink-receiving layer may contain other additive agents. Specific examples of other additive agents include, but are not limited to, a pH-adjusting agent, a thickener, a flow modifier, an antifoaming agent, a foam inhibitor, a surfactant, a mold-release agent, a penetrant, a color pigment, a color dye, a fluorescent brightening agent, an ultraviolet absorber, an antioxidant, a preservative, a fungicide, a water resistance improver, a dye fixative, a curing agent, and a weatherproofer.

### [Method for Manufacturing Recording Medium]

In an embodiment of the present invention, a method for manufacturing a recording medium is not particularly limited and may include a process of preparing a coating liquid for an ink-receiving layer and a process of applying the coating liquid for an ink-receiving layer to a base material. A method for manufacturing a recording medium will be described below.

### <Method for Manufacturing Base Material>

In an embodiment of the present invention, a method for manufacturing a base paper may be a common paper-making method. Examples of a paper-making apparatus include, but are not limited to, a fourdrinier paper machine, a cylinder machine, a drum paper machine, and a twin-wire former. In order to improve the surface smoothness of a base paper, heat and pressure may be applied to the base paper to perform surface treatment during or after the paper-making process. A specific surface treatment method may be calendering, such as machine calendering or supercalendering.

A method for forming a resin layer on a base paper or a method for coating a base paper with a resin may be a melt extrusion process, wet lamination, or dry lamination. In the melt extrusion process, one or both sides of a base paper may be coated with molten resin by extrusion coating. For example, a transported base paper and a resin from an extrusion die are pressed between a nip roller and a cooling roller to form a resin layer on the base paper (also referred to as an extrusion coating process). The extrusion coating process is widely employed. In the formation of a resin layer by the melt extrusion process, pretreatment may be performed to improve adhesion between a base paper and the resin layer. The pretreatment may be acid etching using a mixture of sulfuric acid and chromic acid, flame treatment using gas flame, ultraviolet irradiation treatment, corona discharge treatment, glow discharge treatment, or anchor coating treatment using an alkyl titanate. Among these, corona discharge treatment may be used. When the resin layer contains a white pigment, the base paper may be coated with a mixture of a resin and the white pigment.

### <Method for Forming Ink-Receiving Layer>

An ink-receiving layer of a recording medium according to an embodiment of the present invention may be formed on a base material by the following method. First, a coating liquid for the ink-receiving layer is prepared. The coating liquid is applied to the base material and is dried to produce a recording medium according to an embodiment of the present invention. The coating liquid may be applied with a curtain coater, an extrusion coater, or a slide hopper coater. The coating liquid may be heated during the application. The coating liquid may be dried using a hot-air dryer, such as a linear tunnel dryer, an arch dryer, an air loop dryer, or a sine-curve air float dryer, or an infrared, heating, or microwave dryer. An embodiment of the present invention can suppress cracking of an ink-receiving layer even when a coating liquid was dried at high speed with hot air at 90° C. or more.

### Examples

The present invention will be further described with the following exemplary embodiments and comparative examples. However, the present invention is not limited to these exemplary embodiments. Unless otherwise specified, “part” in the exemplary embodiments is on a mass basis.

### <Synthesis of Compound A>

### Synthesis of Compound A-1

A four-neck flask equipped with a thermometer, a stirring rod, and a reflux condenser was charged with 145.5 parts of a 60% by mass aqueous solution of diallyldimethylammonium chloride (manufactured by Tokyo Chemical Industry Co., Ltd.), which is a “compound represented by General Formula (1)” according to the present invention, 8.65 parts of 4-hydroxybutyl acrylate (manufactured by Tokyo Chemical Industry Co., Ltd.), which is a “compound represented by General Formula (2)” according to the present invention, 0.96 parts of a “chain transfer agent” sodium hypophosphite, and 37.8 parts of pure water. The four-neck flask was then heated to 60° C., and 0.38 parts of a “polymerization initiator” ammonium persulfate was added to the four-neck flask. The four-neck flask was held at a temperature of 60° C. for 10 hours to cause a reaction. The resulting aqueous compound A-1 solution had a weight-average molecular weight (Mw) of 10,000 as determined by gel permeation chromatography. The percentage of unreacted reactants in the compound A-1 was less than 5% as determined by NMR.

### Synthesis of Compounds A-2 to A-18

Compounds A-2 to A-18 were synthesized in the same manner as in the synthesis of the compound A-1 except that the types and amounts of “compound represented by General Formula (1)”, “compound represented by General Formula (2) or (3)”, and “chain transfer agent” and the amount of “polymerization initiator” were determined as listed in the following Table 1. The weight-average molecular weight of the products was measured. The percentage of unreacted reactants in the products was less than 5% as determined by NMR. The abbreviations in Table 1 are as follows:

DADMAC: 60% by mass aqueous solution of diallyldimethylammonium chloride (manufactured by Tokyo Chemical Industry Co., Ltd.)
QDM: Methacryloyloxyethyltrimethylammonium chloride (manufactured by MRC UNITEC Co., Ltd.)
DMAPAA: 75% by mass aqueous solution of dimethylaminopropylacrylamide methyl chloride quaternary salt (manufactured by Kohjin Co., Ltd.)
St: Styrene (manufactured by Tokyo Chemical Industry Co., Ltd.)
4HBA: 4-hydroxybutyl acrylate (manufactured by Tokyo Chemical Industry Co., Ltd.)
2HEA: 2-hydroxyethyl acrylate (manufactured by Tokyo Chemical Industry Co., Ltd.)
2HBA: 2-hydroxybutyl acrylate (manufactured by Kyoeisha Chemical Co., Ltd.)
HEAA: 2-hydroxyethylacrylamide (manufactured by Kohjin Co., Ltd.)
EMA: Ethyl methacrylate (manufactured by Tokyo Chemical Industry Co., Ltd.)

TABLE 1
Synthesis conditions and synthesis results for compound a

| | | | | | | | | | Synthesis results | |
|---|---|---|---|---|---|---|---|---|---|---|
| | Synthesis conditions | | | | | | | | Unit derived from | |
| | Compound | | Compound | | | | Polymerization | | compound represented | |
| | represented | | represented by | | | | initiator: | | by general formula | |
| | by general | | general formula | | | | ammonium | | (1)/unit derived | Weight- |
| | formula (1) | | (2) or (3) | | Chain transfer agent | | persulfate | Water | from compound | average |
| | | Amount | | Amount | | Amount | Amount | Amount | represented by general | molecular |
| Compound | | of used | | of used | | of used | of used | of used | formula (2) or (3) | weight |
| No. | Type | (parts) | Type | (parts) | Type | (parts) | (parts) | (parts) | (mole ratio) | Mw |
| Compound | DADMAC | 145.50 | 4HBA | 8.65 | Sodium | 0.96 | 0.38 | 37.8 | 9.0 | 10000 |
| A-1 | | | | | hypophosphite | | | | | |
| Compound | DADMAC | 113.17 | 4HBA | 25.96 | Sodium | 0.94 | 0.38 | 48.6 | 2.3 | 10000 |
| A-2 | | | | | hypophosphite | | | | | |
| Compound | DADMAC | 80.84 | 4HBA | 43.26 | Sodium | 0.92 | 0.37 | 59.4 | 1.0 | 10000 |
| A-3 | | | | | hypophosphite | | | | | |
| Compound | DADMAC | 48.50 | 4HBA | 60.56 | Sodium | 0.90 | 0.36 | 70.3 | 0.4 | 10000 |
| A-4 | | | | | hypophosphite | | | | | |
| Compound | DADMAC | 113.17 | 4HBA | 25.96 | Mercapto- | 0.94 | 0.38 | 48.6 | 2.3 | 10000 |
| A-5 | | | | | ethanol | | | | | |
| Compound | DADMAC | 113.17 | 2HEA | 20.90 | Sodium | 0.89 | 0.36 | 43.5 | 2.3 | 10000 |
| A-6 | | | | | hypophosphite | | | | | |
| Compound | DADMAC | 113.17 | 2HBA | 25.96 | Sodium | 0.94 | 0.38 | 48.6 | 2.3 | 10000 |
| A-7 | | | | | hypophosphite | | | | | |
| Compound | DADMAC | 113.17 | HEAA | 20.73 | Sodium | 0.89 | 0.35 | 43.4 | 2.3 | 10000 |
| A-8 | | | | | hypophosphite | | | | | |
| Compound | DADMAC | 113.17 | 4HBA | 25.96 | Sodium | 1.41 | 0.38 | 48.6 | 2.3 | 2000 |
| A-9 | | | | | hypophosphite | | | | | |
| Compound | DADMAC | 113.17 | 4HBA | 25.96 | Sodium | 1.13 | 0.38 | 48.6 | 2.3 | 5000 |
| A-10 | | | | | hypophosphite | | | | | |
| Compound | DADMAC | 113.17 | 4HBA | 25.96 | Sodium | 0.75 | 0.38 | 48.6 | 2.3 | 20000 |
| A-11 | | | | | hypophosphite | | | | | |
| Compound | DADMAC | 113.17 | 4HBA | 25.96 | Sodium | 0.47 | 0.38 | 48.6 | 2.3 | 50000 |
| A-12 | | | | | hypophosphite | | | | | |
| Compound | DADMAC | 161.67 | — | 0 | Sodium | 0.97 | 0.39 | 32.3 | — | 10000 |
| A-13 | | | | | hypophosphite | | | | | |
| Compound | QDM | 87.23 | 2HEA | 25.96 | Sodium | 0.78 | 0.31 | 43.4 | 2.3 | 100000 |
| A-14 | | | | | hypophosphite | | | | | |
| Compound | DMAPAA | 115.64 | 2HEA | 20.90 | Sodium | 0.90 | 0.36 | 44.0 | 2.3 | 100000 |
| A-15 | | | | | hypophosphite | | | | | |
| Compound | DADMAC | 113.17 | EMA | 20.55 | Sodium | 0.88 | 0.35 | 43.2 | 2.3 | 10000 |
| A-16 | | | | | hypophosphite | | | | | |
| Compound | St | 43.74 | 2HEA | 25.96 | Sodium | 0.52 | 0.21 | 34.7 | 2.3 | 100000 |
| A-17 | | | | | hypophosphite | | | | | |
| Compound | — | 0 | 4HBA | 86.52 | Sodium | 0.87 | 0.35 | 86.5 | 0 | 10000 |
| A-18 | | | | | hypophosphite | | | | | |

### <Manufacture of Base Material>

Water was added to a mixture of 80 parts of LBKP having a Canadian Standard freeness of 450 mL CSF, 20 parts of NBKP having a Canadian Standard freeness of 480 mL CSF, 0.60 parts of cationized starch, 10 parts of heavy calcium carbonate, 15 parts of light calcium carbonate, 0.10 parts of an alkyl ketene dimer, and 0.030 parts of cationic polyacrylamide such that the solid content was 3.0% by mass to prepare stuff. The stuff was then subjected to a fourdrinier paper machine and a three-stage wet press and was dried with a multi-cylinder dryer. The resulting paper was then impregnated with an aqueous solution of oxidized starch using a size press machine such that the solid content after drying was 1.0 g/m². After drying, the paper was subjected to machine calendering to produce a base paper. The base paper had a basis weight of 170 g/m², a Stockigt sizing degree of 100 seconds, an air permeability of 50 seconds, a Bekk smoothness of 30 seconds, and a Gurley stiffness of 11.0 mN. A resin composition composed of 70 parts of a low-density polyethylene, 20 parts of a high-density polyethylene, and 10 parts of titanium oxide was then applied to one side of the base paper such that the dry coating amount was 25 g/m². This side of the base paper is a front surface of the base material. A resin composition composed of 50 parts of a low-density polyethylene and 50 parts of a high-density polyethylene was applied to the other side of the base paper to complete the base material.

### <Manufacture of Recording Medium>

### Preparation of Coating Liquid 1-1 for Ink-Receiving Layer

A 50% by mass aqueous solution of the compound A-1 was added to 420 parts of ion-exchanged water to prepare an aqueous solution. The amount of the compound A-1 was 5 parts per 100 parts of the solid component of fumed silica to be added later. 100 parts of fumed silica AEROSIL 300 (specific surface area: 300 m²/g) (manufactured by Evonik Industries AG.) was added in small portions to the aqueous solution while stirring with a homo mixer T. K. Homogenizing Mixer Mark II Model 2.5 (manufactured by Tokushu Kika Kogyo Co., Ltd.) at 3,000 rpm. The resulting fumed silica dispersion liquid was treated twice with a high-pressure homogenizer Nanomizer (trade name) (manufactured by Yoshida Kikai Co., Ltd.). The solid density of the fumed silica dispersion liquid was 20% by mass.

A poly(vinyl alcohol) PVA 235 (manufactured by Kuraray Co., Ltd.) was dissolved in ion-exchanged water to prepare an aqueous PVA solution as a binder. The viscosity-average degree of polymerization of PVA 235 is 3500. The degree of saponification of PVA 235 is 88% by mole. The solid density of the aqueous PVA solution was 8.0% by mass.

The fumed silica dispersion liquid was mixed with the aqueous PVA solution. The poly(vinyl alcohol) solid content was 23 parts per 100 parts of the fumed silica solid component in the fumed silica dispersion liquid. The liquid mixture was mixed with an aqueous orthoboric acid solution having a solid density of 5% by mass. The orthoboric acid solid content was 17.4 parts per 100 parts of the poly(vinyl alcohol) solid component. The resulting coating liquid was mixed with 0.1 parts of a surfactant Surfynol 465 (manufactured by Nissin Chemical Industry Co., Ltd.) to prepare a coating liquid 1-1 for ink-receiving layer.

### Preparation of Coating Liquids 1-2 to 1-25 for Ink-Receiving Layer

Coating liquids 1-2 to 1-25 for ink-receiving layer were prepared in the same manner as described above (Preparation of Coating Liquid 1-1 for Ink-Receiving Layer) except that the types of inorganic particles and compound A were determined as listed in the following Table 2. As a result, the coating liquids 1-20, 1-21, 1-24, and 1-25 for ink-receiving layer had increased viscosities. “A200” in the table represents a fumed silica AEROSIL 200 (specific surface area: 200 m²/g) (manufactured by Evonik Industries AG.).

TABLE 2
Preparation of coating liquid for ink-receiving layer

| | | | | | | Cross-linker: | OH group |
|---|---|---|---|---|---|---|---|
| | Inorganic | | | | Binder: | Orthoboric | content |
| Coating | particles | | Compound A | | PVA | acid | ratio: |
| liquid for | | Amount | | Amount | Amount | Amount | Compound |
| ink-receiving | | of used | | of used | of used | of used | A/PVA |
| layer No. | Type | (parts) | Type | (parts) | (parts) | (parts) | (mass %) |
| Coating | A300 | 100 | Compound | 5 | 23 | 4 | 0.8 |
| liquid 1-1 | (fumed | | A-1 | | | | |
| | silica) | | | | | | |
| Coating | A300 | 100 | Compound | 3 | 23 | 4 | 1.4 |
| liquid 1-2 | | | A-2 | | | | |
| Coating | A300 | 100 | Compound | 5 | 23 | 4 | 2.3 |
| liquid 1-3 | | | A-2 | | | | |
| Coating | A300 | 100 | Compound | 5 | 28 | 4 | 1.9 |
| liquid 1-4 | | | A-2 | | | | |
| Coating | A300 | 100 | Compound | 5 | 33 | 4 | 1.6 |
| liquid 1-5 | | | A-2 | | | | |
| Coating | A300 | 100 | Compound | 7 | 23 | 4 | 3.3 |
| liquid 1-6 | | | A-2 | | | | |
| Coating | A300 | 100 | Compound | 9 | 23 | 4 | 4.2 |
| liquid 1-7 | | | A-2 | | | | |
| Coating | A300 | 100 | Compound | 5 | 23 | 4 | 4.0 |
| liquid 1-8 | | | A-3 | | | | |
| Coating | A300 | 100 | Compound | 5 | 23 | 4 | 5.7 |
| liquid 1-9 | | | A-4 | | | | |
| Coating | A300 | 100 | Compound | 5 | 23 | 4 | 2.3 |
| liquid 1-10 | | | A-5 | | | | |
| Coating | A300 | 100 | Compound | 5 | 23 | 4 | 2.5 |
| liquid 1-11 | | | A-6 | | | | |
| Coating | A300 | 100 | Compound | 5 | 23 | 4 | 2.3 |
| liquid 1-12 | | | A-7 | | | | |
| Coating | A300 | 100 | Compound | 5 | 23 | 4 | 2.5 |
| liquid 1-13 | | | A-8 | | | | |
| Coating | A300 | 100 | Compound | 5 | 23 | 4 | 2.3 |
| liquid 1-14 | | | A-9 | | | | |
| Coating | A300 | 100 | Compound | 5 | 23 | 4 | 2.3 |
| liquid 1-15 | | | A-10 | | | | |
| Coating | A300 | 100 | Compound | 5 | 23 | 4 | 2.3 |
| liquid 1-16 | | | A-11 | | | | |
| Coating | A300 | 100 | Compound | 5 | 23 | 4 | 2.3 |
| liquid 1-17 | | | A-12 | | | | |
| Coating | A200 | 100 | Compound | 5 | 23 | 4 | 2.3 |
| liquid 1-18 | (fumed | | A-2 | | | | |
| | silica) | | | | | | |
| Coating | A300 | 100 | Compound | 5 | 23 | 4 | 2.0 |
| liquid 1-19 | | | A-13 | | | | |
| Coating | A300 | 100 | Compound | 5 | 23 | 4 | 2.7 |
| liquid 1-20 | | | A-14 | | | | |
| Coating | A300 | 100 | Compound | 5 | 23 | 4 | 2.5 |
| liquid 1-21 | | | A-15 | | | | |
| Coating | A300 | 100 | Compound | 5 | 23 | 4 | 8.4 |
| liquid 1-23 | | | A-16 | | | | |
| Coating | A300 | 100 | Compound | 5 | 23 | 4 | 2.7 |
| liquid 1-24 | | | A-17 | | | | |
| Coating | A300 | 100 | Compound | 5 | 23 | 4 | 5.5 |
| liquid 1-25 | | | A-18 | | | | |

### Preparation of Coating Liquid 2-1 for Ink-Receiving Layer

The compound H-1 serving as a silane coupling agent and a 50% by mass aqueous solution of the compound A-1 were added to 430 parts by mass of ion-exchanged water. Each of the amounts of the silane coupling agent and the compound A based on solid content was 5 parts per 100 parts of the solid component of fumed silica to be added later. 100 parts of fumed silica AEROSIL 300 (specific surface area: 300 m²/g) (manufactured by Evonik Industries AG.) was added in small portions to the aqueous solution while stirring with a homo mixer T. K. Homogenizing Mixer Mark II Model 2.5 (manufactured by Tokushu Kika Kogyo Co., Ltd.) at 3,000 rpm. The resulting fumed silica dispersion liquid was treated twice with a high-pressure homogenizer Nanomizer (manufactured by Yoshida Kikai Co., Ltd.). The solid density of the fumed silica dispersion liquid was 20% by mass.

A poly(vinyl alcohol) PVA 235 (manufactured by Kuraray Co., Ltd.) was dissolved in ion-exchanged water to prepare an aqueous PVA solution as a binder. The viscosity-average degree of polymerization of PVA 235 is 3500. The degree of saponification of PVA 235 is 88% by mole. The solid density of the aqueous PVA solution was 8.0% by mass.

The fumed silica dispersion liquid was mixed with the aqueous PVA solution. The poly(vinyl alcohol) solid content was 23 parts per 100 parts of the fumed silica solid component in the fumed silica dispersion liquid. The liquid mixture was mixed with an aqueous orthoboric acid solution having a solid density of 5% by mass. The orthoboric acid solid content was 17.4 parts per 100 parts of the poly(vinyl alcohol) solid component. The resulting coating liquid was mixed with 0.1 parts of a surfactant Surfynol 465 (manufactured by Nissin Chemical Industry Co., Ltd.) to prepare a coating liquid 2-1 for ink-receiving layer.

### Preparation of Coating Liquids 2-2 to 2-23 for Ink-Receiving Layer

Coating liquids 2-2 to 2-23 for ink-receiving layer were prepared in the same manner as described above (Preparation of Coating Liquid 2-1 for Ink-Receiving Layer) except that the types of inorganic particles, silane coupling agent, and compound A were determined as listed in the following Table 3. “A200” in the table represents a fumed silica AEROSIL 200 (specific surface area: 200 m²/g) (manufactured by Evonik Industries AG.).

TABLE 3
Preparation of coating liquid for ink-receiving layer

| | | | | | | | | Cross-linker: | OH group |
|---|---|---|---|---|---|---|---|---|---|
| | Inorganic | | Silane coupling | | | | Binder: | Orthoboric | content |
| Coating | particles | | agent | | Compound A | | PVA | acid | ratio: |
| liquid for | | Amount | | Amount | | Amount | Amount | Amount | Compound |
| ink-receiving | | of used | | of used | | of used | of used | of used | A/PVA |
| layer No. | Type | (parts) | Type | (parts) | Type | (parts) | (parts) | (parts) | (mass %) |
| Coating | A300 | 100 | Compound | 5 | Compound | 5 | 23 | 4 | 0.8 |
| liquid 2-1 | | | H-1 | | A-1 | | | | |
| Coating | A300 | 100 | Compound | 5 | Compound | 3 | 23 | 4 | 1.4 |
| liquid 2-2 | | | H-1 | | A-2 | | | | |
| Coating | A300 | 100 | Compound | 5 | Compound | 5 | 23 | 4 | 2.3 |
| liquid 2-3 | | | H-1 | | A-2 | | | | |
| Coating | A300 | 100 | Compound | 5 | Compound | 5 | 23 | 4 | 2.3 |
| liquid 2-4 | | | H-2 | | A-2 | | | | |
| Coating | A300 | 100 | Compound | 5 | Compound | 5 | 23 | 4 | 2.3 |
| liquid 2-5 | | | H-3 | | A-2 | | | | |
| Coating | A300 | 100 | Compound | 5 | Compound | 5 | 23 | 4 | 2.3 |
| liquid 2-6 | | | H-4 | | A-2 | | | | |
| Coating | A300 | 100 | Compound | 5 | Compound | 7 | 23 | 4 | 3.3 |
| liquid 2-7 | | | H-1 | | A-2 | | | | |
| Coating | A300 | 100 | Compound | 5 | Compound | 9 | 23 | 4 | 4.2 |
| liquid 2-8 | | | H-1 | | A-2 | | | | |
| Coating | A300 | 100 | Compound | 3 | Compound | 5 | 23 | 4 | 2.3 |
| liquid 2-9 | | | H-3 | | A-2 | | | | |
| Coating | A300 | 100 | Compound | 5 | Compound | 5 | 23 | 4 | 2.3 |
| liquid 2-10 | | | H-3 | | A-2 | | | | |
| Coating | A300 | 100 | Compound | 10 | Compound | 5 | 23 | 4 | 2.3 |
| liquid 2-11 | | | H-3 | | A-2 | | | | |
| Coating | A300 | 100 | Compound | 13 | Compound | 5 | 23 | 4 | 2.3 |
| liquid 2-12 | | | H-3 | | A-2 | | | | |
| Coating | A300 | 100 | Compound | 13 | Compound | 9 | 23 | 4 | 4.2 |
| liquid 2-13 | | | H-3 | | A-2 | | | | |
| Coating | A300 | 100 | Compound | 5 | Compound | 5 | 23 | 4 | 4.0 |
| liquid 2-14 | | | H-1 | | A-3 | | | | |
| Coating | A300 | 100 | Compound | 5 | Compound | 5 | 23 | 4 | 5.7 |
| liquid 2-15 | | | H-1 | | A-4 | | | | |
| Coating | A300 | 100 | Compound | 5 | Compound | 5 | 23 | 4 | 2.5 |
| liquid 2-18 | | | H-1 | | A-6 | | | | |
| Coating | A300 | 100 | Compound | 5 | Compound | 5 | 23 | 4 | 2.3 |
| liquid 2-19 | | | H-1 | | A-7 | | | | |
| Coating | A300 | 100 | Compound | 5 | Compound | 5 | 23 | 4 | 2.5 |
| liquid 2-20 | | | H-1 | | A-8 | | | | |
| Coating | A300 | 100 | Compound | 5 | Compound | 5 | 23 | 4 | 2.3 |
| liquid 2-21 | | | H-1 | | A-9 | | | | |
| Coating | A300 | 100 | Compound | 5 | Compound | 5 | 23 | 4 | 2.3 |
| liquid 2-22 | | | H-1 | | A-10 | | | | |
| Coating | A300 | 100 | Compound | 5 | Compound | 5 | 23 | 4 | 2.3 |
| liquid 2-23 | | | H-1 | | A-11 | | | | |
| Coating | A300 | 100 | Compound | 5 | Compound | 5 | 23 | 4 | 2.3 |
| liquid 2-24 | | | H-1 | | A-12 | | | | |
| Coating | A200 | 100 | Compound | 5 | Compound | 5 | 23 | 4 | 2.3 |
| liquid 2-25 | | | H-1 | | A-2 | | | | |

### Manufacture of Recording Medium

The coating liquids 1-1 to 1-19, 1-23, and 2-1 to 2-23 for ink-receiving layer were applied to a front side of the base material at a dry film thickness of 40 μm with a slide hopper coating machine. The coating liquids were dried with a hot-air dryer at 130° C., thus completing recording media.

### [Evaluation]

### Evaluation of Cracking of Ink-Receiving Layer

The recording media were visually inspected for cracking of the ink-receiving layer thereof. The evaluation criteria were as follows: Tables 4 and 5 show the results.

A: No crack was observed in the ink-receiving layer.
B: Minor cracks were observed in the ink-receiving layer.
C: Large cracks were observed in the ink-receiving layer.

### Evaluation of Color Developability of Images

A 2.5 cm×2.5 cm black solid image (image having a print duty of 100%) was recorded on the recording media with an ink jet recording apparatus PIXUS MP990 (manufactured by CANON KABUSHIKI KAISHA) equipped with an ink cartridge BCI-321 (manufactured by CANON KABUSHIKI KAISHA) in a “Photo Paper Pro Platinum grade with no color correction” mode. The recording conditions included a temperature of 23° C. and a relative humidity of 50%. The optical density of images was measured with an optical reflection densitometer 530 SpectroDensitometer (manufactured by X-Rite Inc.). The color developability of the images was evaluated from the optical density. A high optical density indicates high color developability of the image. The evaluation criteria were as follows: Tables 4 and 5 show the results.

A: The optical density was 2.20 or more.
B: The optical density was 2.00 or more and less than 2.20.
C: The optical density was less than 2.00.

### Ink Absorbency of Recording Medium

A 2.5 cm×2.5 cm green solid image (image having a print duty of 100%) was recorded on the recording media 1-1 to 1-19 and 1-23 with the ink jet recording apparatus PIXUS MP990 (manufactured by CANON KABUSHIKI KAISHA) equipped with the ink cartridge BCI-321 (manufactured by CANON KABUSHIKI KAISHA) in the “Photo Paper Pro Platinum grade with no color correction” mode. The recording conditions included a temperature of 30° C. and a relative humidity of 80%. The ink absorbency of the recording media was evaluated by inspecting the images for beading visually and with a magnifier. Beading is a phenomenon in which neighboring ink droplets coalesce before being absorbed by a recording medium. Beading is known to be highly correlated with ink absorbency. Thus, no beading indicates high ink absorbency. Table 4 shows the results.

A: No beading was observed even with the magnifier.
B: Beading was observed with the magnifier but was not visually observed.
C: Beading was visually observed.

### Moisture Resistance of Images

A solid image of a secondary color (blue) of cyan and yellow having 48-point and 10-point outline characters “E” (without ink) (hereinafter referred to as a “48-point outline character” and a “10-point outline character”, respectively) was recorded on the recording media 2-1 to 2-23 with the ink jet recording apparatus in the “Photo Paper Pro Platinum grade with no color correction” mode. The print duty of cyan was 150%, and the print duty of yellow was 150%. The moisture resistance of the image was evaluated by storing the image under high-humidity conditions at a temperature of 30° C. and at a relative humidity of 80% for 1 week and visually inspecting the outline characters in the image. The evaluation criteria were as follows: Table 5 shows the results.

A: No color bleeding was observed in the 48-point outline character and the 10-point outline character.
B: Although slight color bleeding was observed in the 48-point outline character, no color bleeding was observed in the 10-point outline character.
C: Minor bleeding was observed in the 48-point outline character and the 10-point outline character.
D: Significant color bleeding was observed in the 48-point outline character and the 10-point outline character, and the original letters could not be read.

TABLE 4
Evaluation result

| | | Evaluation results | | |
|---|---|---|---|---|
| | | Cracking | | |
| Exemplary | Recording | of ink- | Color | |
| embodiment | medium | receiving | developability | Ink |
| No. | No. | layer | of image | absorbency |
| Exemplary | Recording | B | A | A |
| embodiment 1 | medium 1-1 | | | |
| Exemplary | Recording | A | A | A |
| embodiment 2 | medium 1-2 | | | |
| Exemplary | Recording | A | A | A |
| embodiment 3 | medium 1-3 | | | |
| Exemplary | Recording | A | A | A |
| embodiment 4 | medium 1-4 | | | |
| Exemplary | Recording | A | A | B |
| embodiment 5 | medium 1-5 | | | |
| Exemplary | Recording | A | A | A |
| embodiment 6 | medium 1-6 | | | |
| Exemplary | Recording | B | B | A |
| embodiment 7 | medium 1-7 | | | |
| Exemplary | Recording | A | A | A |
| embodiment 8 | medium 1-8 | | | |
| Exemplary | Recording | A | B | B |
| embodiment 9 | medium 1-9 | | | |
| Exemplary | Recording | B | B | B |
| embodiment 10 | medium 1-10 | | | |
| Exemplary | Recording | B | A | A |
| embodiment 11 | medium 1-11 | | | |
| Exemplary | Recording | B | A | A |
| embodiment 12 | medium 1-12 | | | |
| Exemplary | Recording | B | A | A |
| embodiment 13 | medium 1-13 | | | |
| Exemplary | Recording | A | A | A |
| embodiment 14 | medium 1-14 | | | |
| Exemplary | Recording | A | A | A |
| embodiment 15 | medium 1-15 | | | |
| Exemplary | Recording | A | B | A |
| embodiment 16 | medium 1-16 | | | |
| Exemplary | Recording | A | B | A |
| embodiment 17 | medium 1-17 | | | |
| Exemplary | Recording | A | B | A |
| embodiment 18 | medium 1-18 | | | |
| Comparative | Recording | C | B | B |
| example 1 | medium 1-19 | | | |
| Comparative | Recording | C | C | C |
| example 2 | medium 1-23 | | | |

TABLE 5
Evaluation result

| | | Evaluation results | | |
|---|---|---|---|---|
| | | Cracking | | |
| Exemplary | Recording | of ink- | Color | Moisture |
| embodiment | medium | receiving | developability | resistance |
| No. | No. | layer | of image | of image |
| Exemplary | Recording | B | A | B |
| embodiment 19 | medium 2-1 | | | |
| Exemplary | Recording | A | A | B |
| embodiment 20 | medium 2-2 | | | |
| Exemplary | Recording | A | A | A |
| embodiment 21 | medium 2-3 | | | |
| Exemplary | Recording | A | A | A |
| embodiment 22 | medium 2-4 | | | |
| Exemplary | Recording | A | B | B |
| embodiment 23 | medium 2-5 | | | |
| Exemplary | Recording | A | A | A |
| embodiment 24 | medium 2-6 | | | |
| Exemplary | Recording | A | A | A |
| embodiment 25 | medium 2-7 | | | |
| Exemplary | Recording | B | B | B |
| embodiment 26 | medium 2-8 | | | |
| Exemplary | Recording | A | A | B |
| embodiment 27 | medium 2-9 | | | |
| Exemplary | Recording | A | A | B |
| embodiment 28 | medium 2-10 | | | |
| Exemplary | Recording | A | A | B |
| embodiment 29 | medium 2-11 | | | |
| Exemplary | Recording | A | B | B |
| embodiment 30 | medium 2-12 | | | |
| Exemplary | Recording | A | B | B |
| embodiment 31 | medium 2-13 | | | |
| Exemplary | Recording | A | A | A |
| embodiment 32 | medium 2-14 | | | |
| Exemplary | Recording | A | B | B |
| embodiment 33 | medium 2-15 | | | |
| Exemplary | Recording | B | A | B |
| embodiment 34 | medium 2-16 | | | |
| Exemplary | Recording | B | A | B |
| embodiment 35 | medium 2-17 | | | |
| Exemplary | Recording | B | A | B |
| embodiment 36 | medium 2-18 | | | |
| Exemplary | Recording | A | A | A |
| embodiment 37 | medium 2-19 | | | |
| Exemplary | Recording | A | A | A |
| embodiment 38 | medium 2-20 | | | |
| Exemplary | Recording | A | A | B |
| embodiment 39 | medium 2-21 | | | |
| Exemplary | Recording | A | B | B |
| embodiment 40 | medium 2-22 | | | |
| Exemplary | Recording | A | B | B |
| embodiment 41 | medium 2-23 | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-003146, filed Jan. 10, 2014, which is hereby incorporated by reference herein in its entirety.

What is claimed is:

1. A recording medium, comprising: a base material; and an ink-receiving layer, wherein
the ink-receiving layer comprises inorganic particles, a binder, and a compound A, the compound A containing a unit derived from a compound represented by General Formula (1) and a unit derived from at least one compound selected from compounds represented by General Formula (2) and compounds represented by General Formula (3), 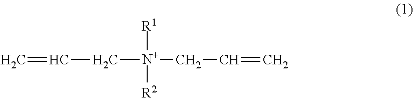
wherein R¹ and R² each independently represent an alkyl group having 1 to 10 carbon atoms, a cycloalkyl group having 5 to 10 carbon atoms, or an aralkyl group having 7 to 10 carbon atoms, 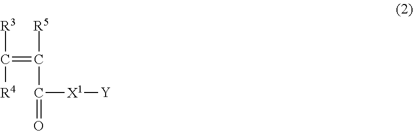
wherein R³, R⁴, and R⁵ each independently represent a hydrogen atom or an alkyl group having 1 to 4 carbon atoms, X¹ represents an oxygen atom or an amino group, and Y represents a hydroxyalkyl group or an aminoalkyl group each having 1 to 10 carbon atoms, and 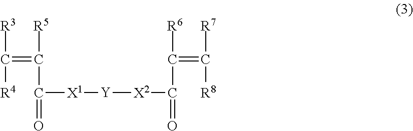
wherein R³, R⁴, R⁵, R⁶, R⁷ and R⁸ each independently represent hydrogen or an alkyl group having 1 to 4 carbon atoms, X¹ and X² each independently represent an oxygen atom or an amino group, and Y represents a hydroxyalkylene group or an aminoalkylene group each having 1 to 10 carbon atoms.

2. The recording medium according to claim 1, wherein the compound A is a copolymer of a compound represented by General Formula (1) and at least one compound selected from compounds represented by General Formula (2) and compounds represented by General Formula (3).

3. The recording medium according to claim 1, wherein the mole ratio of the unit derived from a compound represented by General Formula (1) to the unit derived from at least one compound selected from compounds represented by General Formula (2) and compounds represented by General Formula (3) in the compound A is 1.0 or more and 9.0 or less.

4. The recording medium according to claim 1, wherein the binder comprises poly(vinyl alcohol).

5. The recording medium according to claim 4, wherein the hydroxyl group content of the compound A is 1% by mass or more and 10% by mass or less of the hydroxyl group content of the poly(vinyl alcohol).

6. The recording medium according to claim 1, wherein the compound represented by General Formula (1) is diallyldimethylammonium chloride, and the at least one compound selected from compounds represented by General Formula (2) and compounds represented by General Formula (3) is a hydroxyalkyl(meth)acrylate.

7. The recording medium according to claim 1, wherein the inorganic particles have a structure represented by General Formula (4): 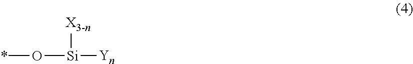
wherein the structure represented by General Formula (4) is bonded to a surface of the inorganic particle at a position marked with *, and
wherein, in General Formula (4),
X represents any one of an alkoxy group having 1 to 8 carbon atoms, an aryloxy group, an acetoxy group, a halogen atom, a hydrogen atom, a hydrocarbon group having 1 to 8 carbon atoms, and —O—*,
Y represents a structure including a primary hydroxyl group, and
n is 1, 2, or 3.
